(19) United States
(12) Patent Application Publication
(10) Pub. No.: US 2002/0008336 A1
(43) Pub. Date: Jan. 24, 2002

(54) FERRITE MATERIAL, METHOD OF MANUFACTURING THE SAME AND DEFLECTION YOKE CORE MADE FROM THE MATERIAL

(76) Inventors: SHUICHI OTOBE, SHIZUOKA (JP); TETUJI AKIYAMA, SHIZUOKA (JP); YASUYUKI MASUDA, AICHI (JP)

Correspondence Address: WENDEROTH LIND & PONACK, 2033 K STREET NW, SUITE 800, WASHINGTON, DC, 20006

(21) Appl. No.: 09/341,864

(22) PCT Filed: Jan. 20, 1998
(86) PCT No.: PCT/JP98/00202

(30) Foreign Application Priority Data
Jan. 21, 1997 (JP) 9-009029

(51) Int. Cl. C04B 33/32; C04B 35/38

(52) U.S. Cl. 264/612; 264/613; 501/126

(57) ABSTRACT

Provided are an inexpensive Mn—Zn ferrite material having a high resistance, a high permeability, and a low core loss, a manufacturing method thereof, and a deflection yoke core using the material. The ferrite material contains, as main components, 43.0-49.5 mol % of Fe₂O₃, 33.5-49.0 mol % of MnO, and 8.0-17.0 mol % of ZnO, wherein the ratio of ZnO mol %/Fe₂O₃ mol % is in a range of 0.35 or less. Preferably, the ferrite material further contains, as sub-components, at least one or more of 0.006-0.12 wt % of CaO, 0.001-0.05 wt % of SiO₂, and 0.1-1.0 wt % of Bi₂O₃. The oxygen concentration of its atmosphere for sintering of the deflection yoke core is specified in a range of 3 to 13%. Preferably, the cooling rate until cooled to 500° C. after the sintering is set in a range of 120° C./hr to 400° C./hr.

### TECHNICAL FIELD

The present invention relates to a ferrite material suitable for manufacturing a deflection yoke core for an image display such as a television receiver or a CRT display, a deflection yoke core manufactured using the material, and a manufacturing method thereof.

### BACKGROUND ART

As ferrite core materials for the above deflection yoke for an image display, there have been used a Mg—Zn ferrite material and a Mn—Zn ferrite material.

The Mn—Zn ferrite material generally contains, as main components, 51-55 mol % of Fe₂O₃, 20-45 mol % of MnO, and 5-25 mol % of ZnO.

When compared with the Mn—Zn ferrite material, the Mg—Zn ferrite material is inferior in magnetic characteristics inherent to the material, and thereby it exhibits a larger core loss and a smaller initial permeability. Accordingly, when applied to a CRT deflection yoke used in a high frequency band, the core made from the Mg—Zn ferrite material causes a problem that the self-heat generation of the core becomes larger and thereby a degradation in image quality such as color deviation occurs on a screen. On the other hand, the Mn—Zn ferrite material is low in its resistance because it contains Fe₂O₃ in a large amount. Accordingly, for the purpose of making the deflection yoke, the core conventionally made from the Mn—Zn ferrite material should have its surface covered with an insulating coating, or otherwise the core should have been sintered in some costly atmosphere. Such treatments highly increase the manufacturing cost.

### DISCLOSURE OF INVENTION

An object of the present invention is to provide an inexpensive Mn—Zn ferrite material having a high resistance, a high permeability, and a low core loss, a deflection yoke core using the material, and a manufacturing method thereof.

To achieve the above object, according to an invention described in claim 1, there is provided a ferrite material containing, as main components, 43.0-49.5 mol % of Fe₂O₃, 33.5-49.0 mol % of MnO, and 8.0-17.0 mol % of ZnO, wherein the ratio of ZnO mol %/Fe₂O₃ mol % is in a range of 0.35 or less.

With this configuration, the ferrite material of the present invention can exhibit an initial permeability higher than the initial permeability (380) of the conventional Mg—Zn ferrite material and a core loss smaller than the core loss value (32 kW/m³) of the Mg—Zn ferrite material measured under a condition of 100 kHz, 20 mT and 80° C. The ferrite material of the present invention can also exhibit a surface resistance and an inner resistance each of which is as large as 1 MΩ or more, and consequently, such a ferrite material can be suitably used for a deflection yoke core without necessity of a treatment such as coating as the conventional Mn—Zn ferrite material.

The above ferrite material can further contain, as sub-components, at least one or more of 0.006-0.12 wt % of CaO, 0.001-0.05 wt % of SiO₂, and 0.1-1.0 wt % of Bi₂O₃ for further improving the core loss.

According to the present invention, there is also provided a method of manufacturing a deflection yoke core including the steps of: preparing a ferrite material containing, as main components, 43.0-49.5 mol % of Fe₂O₃, 33.5-49.0 mol % of MnO, and 8.0-17.0 mol % of ZnO wherein the ratio of ZnO mol %/Fe₂O₃ mol % is in a range of 0.35 or less, by mixing raw materials; calcining and pulverizing the ferrite material thus prepared; adding a binder and water to the ferrite material thus pulverized; kneading it; pelletizing it; forming the pellets thus obtained into a ring-shape ferrite material; sintering the ring-shape ferrite material at a specific temperature, wherein the oxygen concentration is in a range of 3 to 13% during the sintering. With this configuration, it is possible to manufacture a deflection yoke core having a small core loss.

Preferably, in the above method of manufacturing a deflection yoke core, the cooling rate until cooled to 500° C. after the sintering is in a range of 120° C./hr to 400° C./hr. With this configuration, it is possible to manufacture a deflection yoke core without occurrence of cracks.

In the case of manufacturing a deflection yoke core using the above ferrite material in accordance with the above manufacturing method, since the core loss of the ferrite material of the core is smaller than that of the Mg—Zn ferrite material, the heat generation of the core can be suppressed at a small value. Further, since the surface resistance of the ferrite material of the above core is sufficiently high, the surface of the core is not required to be covered with an insulating coating as a core of the conventional Mn—Zn ferrite material, thereby reducing the cost of the core.

### BEST MODE FOR CARRYING OUT THE INVENTION

Raw materials, Fe₂O₃, MnO and ZnO as main components of a Mn—Zn ferrite material were weighed and mixed at various mixing ratios. Each of the mixtures thus obtained was calcined in air at 850° C. for 2 hr and then pulverized for 4 hr by a ball mill. Then, 1.5 wt % of polyvinyl alcohol as a binder and 1 wt % of water were added to the mixture thus pulverized. The resultant mixture was kneaded and pelletized. The pellets thus obtained were formed into a ring-shape material having an outside diameter of 25 mm, an inside diameter of 15 mm, and a height of 5 mm. The resultant ring-shape material was sintered in an atmosphere containing oxygen at an oxygen concentration of 10% at 1300° C. for 3 hr and then cooled at a cooling rate of 120° C./hr. In this way, Sample Nos. (1) to (30) were obtained. Each sample was then measured in terms of core loss Pc (kW/m³), permeability μi, Curie temperature Tc (° C.), surface resistance Rs (MΩ), and inner resistance Ri (MΩ). The results are shown in Table 1.

TABLE 1

| | | | | | | | | | | CE - comparative |
|---|---|---|---|---|---|---|---|---|---|---|
| | | | | | | | | | | example |
| Sample | Fe₂O₃ | MnO | ZnO | | Pc | | Tc | Rs | Ri | IN - inventive |
| No. | mol % | mol % | mol % | Z/F | KW/m³ | μi | ° C. | MΩ | MΩ | example |
| 1 | 42 | 46 | 12 | 0.26 | 34.1 | 394 | 152 | 25 | 5.1 | CE |
| 2 | 43 | 50 | 7 | 0.17 | 33.7 | 391 | >180 | 30 | 5.1 | CE |
| 3 | ″ | 49 | 8 | 0.19 | 31.9 | 386 | >180 | 25 | 5 | IN |
| 4 | ″ | 44 | 13 | 0.3 | 28 | 425 | 155 | 31 | 5.3 | ″ |
| 5 | ″ | 42 | 15 | 0.35 | 28.5 | 441 | 132 | 28 | 5 | ″ |
| 6 | ″ | 41 | 16 | 0.37 | 28.6 | 450 | 119 | 30 | 4.7 | CE |
| 7 | 45 | 48 | 7 | 0.16 | 33.9 | 585 | >180 | 36 | 4.4 | CE |
| 8 | ″ | 47 | 8 | 0.18 | 31.6 | 596 | >180 | 25 | 4 | IN |
| 9 | ″ | 44 | 11 | 0.24 | 27 | 635 | 180 | 35 | 4.3 | ″ |
| 10 | ″ | 40 | 15 | 0.33 | 24.1 | 662 | 142 | 34 | 3.9 | ″ |
| 11 | ″ | 39 | 16 | 0.36 | 24.5 | 676 | 129 | 31 | 4.1 | CE |
| 12 | 47 | 46 | 7 | 0.15 | 34 | 743 | >180 | 30 | 2.7 | CE |
| 13 | ″ | 45 | 8 | 0.17 | 31.8 | 766 | >180 | 35 | 2.4 | IN |
| 14 | ″ | 41 | 12 | 0.26 | 20.6 | 825 | >180 | 34 | 2.7 | ″ |
| 15 | ″ | 38 | 15 | 0.32 | 19.5 | 885 | 152 | 37 | 2.8 | ″ |
| 16 | ″ | 37 | 16 | 0.34 | 19.6 | 892 | 140 | 39 | 2.5 | ″ |
| 17 | ″ | 36 | 17 | 0.36 | 20.5 | 901 | 125 | 38 | 2.6 | CE |
| 18 | 49 | 44 | 7 | 0.14 | 33.5 | 965 | >180 | 37 | 1.5 | CE |
| 19 | ″ | 43 | 8 | 0.16 | 30 | 975 | >180 | 35 | 1.7 | IN |
| 20 | ″ | 39 | 12 | 0.24 | 18.7 | 1022 | >180 | 35 | 1.6 | ″ |
| 21 | ″ | 36 | 15 | 0.31 | 17.5 | 1040 | 162 | 35 | 1.2 | ″ |
| 22 | ″ | 34 | 17 | 0.35 | 17.6 | 1068 | 138 | 35 | 1.3 | ″ |
| 23 | ″ | 33 | 18 | 0.37 | 18.6 | 1070 | 128 | 35 | 1.2 | CE |
| 24 | 49.5 | 43.5 | 7 | 0.14 | 33.8 | 980 | >180 | 24 | 1.3 | CE |
| 25 | ″ | 42.5 | 8 | 0.16 | 30.5 | 992 | >180 | 31 | 1.2 | IN |
| 26 | ″ | 38.5 | 12 | 0.24 | 19.2 | 1032 | >180 | 31 | 1.3 | ″ |
| 27 | ″ | 35.5 | 15 | 0.3 | 18.4 | 1075 | 164 | 36 | 1.1 | ″ |
| 28 | ″ | 33.5 | 17 | 0.34 | 19.1 | 1085 | 140 | 34 | 1.1 | ″ |
| 29 | ″ | 32.5 | 18 | 0.36 | 19.6 | 1092 | 128 | 34 | 1 | CE |
| 30 | 50 | 35 | 15 | 0.3 | 20.2 | 1072 | 170 | 15 | 0.1 | CE |

*Pc, measured at 100 KHz, 20 mT and 80° C.
*μi, measured at 100 KHz and 25° C.

The samples were evaluated on the basis of the results of Table 1. The ferrite materials, each of which contains 42 mol % or less of Fe₂O₃ as Sample No. 1, are unsuitable because the core loss is as large as 32 kW/m³ or more equivalent to that of the conventional Mg—Zn ferrite material. The ferrite materials, each of which contains more than 50 mol % of Fe₂O₃ as Sample No. 30, are unsuitable because the internal resistance becomes significantly small. The ferrite materials, each of which contains 43.0-49.5 mo % of Fe₂O₃ and less than 8.0 mol % of ZnO as Sample Nos. 2, 7, 12, 18 and 24, are unsuitable because the core loss is as large as 32 kW/m³ or more equivalent to the conventional value. The ferrite materials, in each of which the ratio of ZnO mol %/Fe₂O₃ mol % is in a range of more than 0.35 as Samples Nos. 6, 11, 17, 23 and 29, are unsuitable from the practical viewpoint because the Curie temperature becomes 130° C. or less.

From the above examination of the results of Table 1, it becomes apparent that the ferrite materials, each of which contains 43.0-49.5 mol % of Fe₂O₃, 33.5-49.0 mol % of MnO and 8.0-17.0 mol % of ZnO and has the ratio of ZnO mol %/Fe₂O₃ mol % in a range of 0.35 or less as Sample Nos. 3 to 5, 8 to 10, 13 to 16, 19 to 22, and 25 to 28, can be suitably used for a deflection yoke core without necessity of the conventional treatment such as coating because the permeability is higher than that of the Mg—Zn ferrite material, the core loss is as small as 32 kW/m³ or less, the Curie temperature is as high as 130° C. or more, and each of the surface resistance and inner resistance is as large as 1 MΩ or more.

In further preferred mode of the present invention, to further reduce the optimum value of the core loss listed in Table 1, that is, the value of 17.5 kW/m³ of Sample No. 21, sub-components were added to the above ferrite material. As examples of the sub-components to be added, CaO and SiO₂ were selected to reduce the core loss by forming a high resistance layer at grain boundaries of the above ferrite material and reducing the eddy current loss which becomes undesirable in use of the core made from the above ferrite material at a high frequency. Further, as another example of the sub-component to be added, Bi2O3 was selected to reduce the core loss by promoting the growth of crystal grains of the above ferrite material, to enlarge the sizes of the crystal grains, thereby reducing the hysteresis loss.

The above sub-components were added to a ferrite material having the same composition as that of Sample No. 21 in Table 1 singly or in combination at various mixing ratios. Each of the samples thus obtained was measured in terms of core loss. The results are shown in Table 2.

TABLE 2

| | | | | | CE--comparative |
|---|---|---|---|---|---|
| Sample | CaO | SiO2 | Bi2O3 | core loss | example |
| No. | wt % | wt % | wt % | kW/m³ | IN--inventive example |
| 31 | 0.004 | — | — | 18.5 | CE |
| 32 | 0.005 | — | — | 17.7 | CE |
| 33 | 0.006 | — | — | 17.0 | IN |
| 34 | 0.03 | — | — | 15.4 | ″ |
| 35 | 0.06 | — | — | 14.8 | ″ |
| 36 | 0.12 | — | — | 16.1 | ″ |
| 37 | 0.13 | — | — | 17.6 | CE |
| 38 | 0.15 | — | — | 18.3 | CE |
| 39 | — | 00008 | — | 18.9 | CE |
| 40 | — | 00009 | — | 17.6 | IN |
| 41 | — | 0.001 | — | 17.0 | ″ |
| 42 | — | 0.01 | — | 15.5 | ″ |
| 43 | — | 0.02 | — | 14.6 | ″ |
| 44 | — | 0.05 | — | 16.5 | ″ |
| 45 | — | 0.06 | — | 18.1 | CE |
| 46 | — | 0.08 | — | 19.1 | CE |
| 47 | — | — | 0.08 | 18.6 | CE |
| 48 | — | — | 0.09 | 17.6 | CE |
| 49 | — | — | 0.1 | 16.8 | IN |
| 50 | — | — | 0.4 | 15.0 | ″ |
| 51 | — | — | 0.7 | 16.3 | ″ |
| 52 | — | — | 1.0 | 17.0 | ″ |
| 53 | — | — | 1.1 | 18.3 | CE |
| 54 | — | — | 1.2 | 19.7 | CE |
| 55 | 0.03 | 0.01 | — | 15.5 | IN |
| 56 | 0.06 | 0.02 | — | 14.6 | ″ |
| 57 | 0.03 | — | 0.2 | 15.8 | ″ |
| 58 | 0.06 | — | 0.4 | 15.1 | ″ |
| 59 | — | 0.01 | 0.2 | 15.7 | ″ |
| 60 | — | 0.02 | 0.4 | 14.9 | ″ |
| 61 | 0.03 | 0.01 | 0.2 | 15.6 | ″ |
| 62 | 0.06 | 0.02 | 0.4 | 14.9 | ″ |
| NO. 21 | — | — | — | 17.5 | CE |

note: core loss, measured at 100 kHz, 20 mT and 80° C.

The samples were evaluated on the basis of the results shown in Table 2. Each of Samples Nos. 33 to 36, which contains 0.006-0.12 wt % of CaO, exhibits a core loss lower than that of Sample No. 21. Each of Sample Nos. 41 to 44, which contains 0.001-0.05 wt % of SiO₂, exhibits a core loss lower than that of Sample No. 21 and each of Samples Nos. 49 to 52, which contains 0.1-1.0 wt % of Bi₂O₃, also exhibits a core loss lower than that of Samples No. 21. Each of Sample Nos. 55 to 60, which contains two kinds of the sub-components in the above respective ranges, exhibits a core loss lower than that of Sample No. 21. Each of Sample Nos. 61 and 62, which contains three kinds of the sub-components in the above respective ranges, also exhibits a core loss lower than that of Sample No. 21.

From the above examination of the results of Table 2, it is apparent that the core loss can be further improved by adding, at least one of the sub-components, 0.006-0.12 wt % of CaO, 0.001-0.05 wt % of SiO₂ and 0.1-1.0 wt % of Bi₂O₃, to the ferrite material, wherein the ferrite material contains, as the main components, 43.0-49.5 mol % of Fe₂O₃, 33.5-49.0 mol % of MnO, and 8.0-17.0 mol % of ZnO wherein the ratio of ZnO mol %/Fe₂O₃ mol % is in a range of 0.35 or less.

In the above experiment making embodiments of the present invention, the oxygen concentration during sintering of the deflection yoke was set at 10%. A further experiment was carried out to examine how the core loss, inner resistance and surface resistance depend on oxygen concentration in the sintering atmosphere. For making each sample in this experiment, a ferrite material containing, as main components, 49 mol % of Fe₂O₃, 36 mol % of MnO and 15 mol % of ZnO equivalent to the composition of Sample No. 21 in Table 1 was prepared by mixing, calcining, pulverizing and forming under the same condition as that in the experiment shown in Table 1, and was then sintered at 1300° C. in an atmosphere containing oxygen at a concentration value respectively set for each sample. In this way, Sample Nos. 63 to 73 were obtained. The measurement results for the samples are shown in Table 3.

TABLE 3

| Sample | PO2 | Pc | Rs | Ri | CE--comparative example |
|---|---|---|---|---|---|
| No. | % | kW/m³ | MΩ | MΩ | IN--inventive example |
| 63 | 2 | 17.6 | 15 | 0.3 | CE |
| 64 | 2.5 | 17.1 | 18 | 0.5 | CE |
| 65 | 3 | 17 | 21 | 1 | IN |
| 66 | 5 | 16.9 | 28 | 1 | ″ |
| 67 | 8 | 17.1 | 32 | 1.1 | ″ |
| 21 | 10 | 17.5 | 35 | 1.2 | ″ |
| 68 | 12 | 17.5 | 35 | 1.8 | ″ |
| 69 | 13 | 17.5 | 36 | 2.1 | ″ |
| 70 | 14 | 18.6 | 38 | 2.5 | CE |
| 71 | 15 | 25.4 | 39 | 2.7 | ″ |
| 72 | 17 | 31.8 | 38 | 3.5 | ″ |
| 73 | 17.5 | 33.1 | 41 | 4.1 | ″ |

*PC, measured at 100 kHz, 20 mT and 80° C.

As is apparent from Table 3, the sample manufactured at an oxygen concentration of less than 3% is unsuitable for a deflection yoke core because the inner resistance is very lower than 1 MΩ. On the other hand, the sample manufactured at an oxygen concentration of more than 14% is also unsuitable for a deflection yoke core because the core loss is degraded.

Accordingly, it is apparent from the results of Table 3 that the preferable oxygen concentration during the sintering is in a range of 3 to 13%.

In the above embodiment of the present invention, the slowly cooling rate after sintering of the deflection yoke core was set at 120° C./hr. With respect to the cooling rate, a further experiment was made to examine how the cooling rate exerts an effect on the core loss. For making each sample in this experiment, a ferrite material containing, as main components, 49 mol % of Fe₂O₃, 36 mol % of MnO and 15 mol % of ZnO equivalent to the composition of Sample No. 21 in Table 1 was prepared by mixing, calcining, pulverizeing and forming under the same condition as that in the embodiment shown in Table 1, was then sintered in an atmosphere containing oxygen at an oxygen concentration of 10% and was then slowly cooled at a cooling rate respectively specified for each sample until cooled to 500° C. Thus, Sample Nos. 74 to 83 were obtained. In this connection, a similar series of samples, i.e., Sample Nos. 84 to 90 were obtained except that the oxygen concentration was 5%. Each of the Samples Nos. 74-90 was measured in terms of electromagnetic characteristics and in terms of presence or absence of cracks in the core. The results are shown in Table 4. It should be noted that each was self-cooled from 500° C. to room temperature.

TABLE 4

| | | | | | | Presence or |
|---|---|---|---|---|---|---|
| Sample | Cooling rate | PO2 | Pc | Rs | Ri | absence of |
| No. | ° C./h | % | kW/m³ | MΩ | MΩ | cracks |
| 74 | 70 | 10.0 | 33.8 | 38.0 | 1.8 | absence |
| 75 | 80 | 10.0 | 31.6 | 36.0 | 1.7 | absence |
| 76 | 100 | 10.0 | 25.6 | 37.0 | 1.5 | absence |
| 21 | 120 | 10.0 | 17.5 | 35.0 | 1.2 | absence |
| 77 | 180 | 10.0 | 16.5 | 34.0 | 1.2 | absence |
| 78 | 240 | 10.0 | 16.4 | 30.0 | 1.2 | absence |
| 79 | 300 | 10.0 | 15.8 | 25.0 | 1.1 | absence |
| 80 | 360 | 10.0 | 14.8 | 20.0 | 1.0 | absence |
| 81 | 400 | 10.0 | 15.6 | 18.0 | 1.0 | absence |
| 82 | 420 | 10.0 | | | | presence |
| 83 | 500 | 10.0 | | | | presence |
| 84 | 100 | 5.0 | 24.8 | 30.0 | 1.4 | absence |
| 85 | 120 | 5.0 | 16.9 | 28.0 | 1.0 | absence |
| 86 | 180 | 5.0 | 15.9 | 27.0 | 1.0 | absence |
| 87 | 300 | 5.0 | 15.3 | 20.0 | 1.0 | absence |
| 88 | 360 | 5.0 | 14.3 | 16.0 | 1.0 | absence |
| 89 | 400 | 5.0 | 15.0 | 14.0 | 1.0 | absence |
| 90 | 420 | 5.0 | | | | presence |

*Pc, measured at 100 kHz, 20 mT and 80° C.

As is apparent from Table 4, for the sample manufactured under the condition in which the cooling rate is less than 120° C./hr, the core loss is significantly increased, that is, the magnetic characteristics are bad. On the other hand, for the sample manufactured under the condition in which the cooling rate is more than 400° C./hr, the core is cracked and thereby it cannot be practically used. Accordingly, from the results of Table 4, it is apparent that the preferable cooling rate after the sintering and until cooled to be 500° C. is in a range of 120° C./hr to 400° C./hr.

The heat generation of the core, which was manufactured using the above material in accordance with the above manufacturing method and was used for a deflection yoke, was measured. The results are shown in Table 5. In addition, the deflection yoke core was formed into a shape having a large outside diameter of 100 mm, a small outside diameter of 70 mm and a height of 50 mm, and also having a volume of 100 cm³.

TABLE 5

| | | core | temperature rise |
|---|---|---|---|
| | core material | loss | (core portion) |
| conventional | Mg—Zn ferrite | 1900 mW | 42° C. |
| example | material | | |
| inventive | high resistance | 1150 mW | 39° C. |
| example | Mn—Zn ferrite | | |
| | material | | |

As is apparent from Table 5, for the deflection yoke using the core made from the ferrite material of the present invention, the temperature rise is 3° C. lower than that of the deflection yoke using the core made from the conventional Mg—Zn ferrite material. Consequently, when applied to a CRT deflection yoke used in a high frequency band, the deflection yoke of the present invention does not cause a degradation in image quality such as color deviation.

### INDUSTRIAL APPLICABILITY

As described above, the ferrite material of the present invention exhibits a magnetic permeability higher than that of the conventional Mg—Zn ferrite material and a core loss being as small as 32 kW/m³ or less. The ferrite material also exhibits a surface resistance and an inner resistance each of which is as large as 1 MΩ or more, and therefore, such a ferrite material can be suitably used for a deflection yoke core without necessity of a treatment such as coating which has been required for the conventional Mn—Zn ferrite material.

The core loss can be further improved by adding, at least one of the sub-components, 0.006-0.12 wt % of CaO, 0.001-0.05 wt % of SiO₂ and 0.1-1.0 wt % of Bi₂O₃ to the above ferrite material.

In the method of manufacturing a deflection yoke core according to the present invention, a deflection yoke core having a small core loss can be manufactured.

Preferably, in the above method of the manufacturing a deflection yoke core, the cooling rate until cooled to 500° C. after the sintering and may be specified in a range of 120° C./hr to 400° C./hr. With this configuration, a deflection yoke core can be manufactured without occurrence of cracks.

What is claimed is:

1. A ferrite material containing, as main components, 43.0-49.5 mol % of Fe₂O₃, 33.5-49.0 mol % of MnO, and 8.0-17.0 mol % of ZnO, wherein the ratio of ZnO mol %/Fe₂O₃ mol % is in a range of 0.35 or less.

2. A ferrite material obtained by adding at least one or more of 0.006-0.12 wt % of CaO, 0.001-0.05 wt % of SiO₂, and 0.1-1.0 wt % of Bi₂O₃ as sub-components, to the ferrite material of claim 1.

3. A method of manufacturing a deflection yoke core comprising the steps of:
mixing raw materials to prepare a ferrite material containing 43.0-49.5 mol % of Fe₂O₃, 33.5-49.0 mol % of MnO and 8.0-17.0 mol % of ZnO as main components, wherein the ratio of ZnO mol %/Fe₂O₃ mol % is in a range of 0.35 or less;
calcining and pulverizing the ferrite material thus prepared;
adding a binder and water to the ferrite material thus pulverized;
kneading and pelletizing the thus obtained mixture of the pulverized ferrite material, the binder and the water;
forming the thus obtained pellets into a ring-shape ferrite material;
sintering the ring-shape ferrite material at a specific temperature, wherein the oxygen concentration is in a range of 3 to 13% during the sintering; and,
slowly cooling the sintered ring-shape ferrite material.

4. A method of manufacturing a deflection yoke core according to claim 3, wherein the cooling rate after the sintering and until cooled to 500° C. is in a range of 120° C./hr to 400° C./hr.

5. A deflection yoke core manufactured using a ferrite material described in one of claims 1 and 2 in accordance with a manufacturing method described in one of claims 3 and 4.
